(19) United States
(12) Patent Application Publication
(10) Pub. No.: US 2012/0260080 A1
(43) Pub. Date: Oct. 11, 2012

(54) Method and Apparatus for Preprocessing Operations During a Boot Process

(75) Inventor: Srikanth Myadam, Bangalore (IN)

(73) Assignee: NOKIA CORPORATION, Espoo (FI)

(21) Appl. No.: 13/439,060

(22) Filed: Apr. 4, 2012

(30) Foreign Application Priority Data
Apr. 8, 2011 (IN) 1240/CHE/2011

(51) Int. Cl. G06F 9/00

(52) U.S. Cl. 713/2

(57) ABSTRACT

Various methods for preprocessing operations during a boot process are provided. One example method may include determining that a priority of operations being implemented by the processor at a particular time during the boot process is less than a threshold priority, and in response to determining that the priority of operations being implemented by the processor is less than the threshold priority, performing at least one operation during the boot process, in advance of a scheduled position within a sequence of operations. Similar and related example methods, example apparatuses, and example computer program products are also provided.

### RELATED APPLICATION

This application claims priority benefit to Indian Patent Application Number 1240/CHE/2011, filed Apr. 8, 2011, which is incorporated herein in its entirety by reference.

### TECHNICAL FIELD

Various embodiments relate generally to operating system functionality, and, more particularly, relate to a method and apparatus for preprocessing operations during a boot process.

### BACKGROUND

Operating systems provide the building block upon which higher level applications may be implemented. As such, even with superior hardware, inefficiencies at the operating system level can have enormous impacts on the speed at which applications and other operations are implemented. These inefficiencies can lead to a degradation in the user experience. For example, the delay associated with an extended boot time of a device can lead user frustration, particularly when desired functionality must be implemented quickly. Improvements in, for example, the boot time of a device are therefore desirable.

### SUMMARY

Example methods, example apparatuses, and example computer program products are described herein that provide preprocessing operations during a boot process. One example method may include determining that a priority of operations being implemented by the processor at a particular time during the boot process is less than a threshold priority, and in response to determining that the priority of operations being implemented by the processor is less than the threshold priority, performing at least one operation during the boot process, in advance of a scheduled position within a sequence of operations.

An additional example embodiment is an apparatus configured to preprocess operations during a boot process. The example apparatus may comprise at least one processor and at least one memory including computer program code, where the at least one memory and the computer program code are configured to, with the at least one processor, cause the apparatus to perform various functionalities. In this regard, the example apparatus may be caused to determine that a priority of operations being implemented by the processor at a particular time during the boot process is less than a threshold priority, and in response to determining that the priority of operations being implemented by the processor is less than the threshold priority, performing at least one operation during the boot process, in advance of a scheduled position within a sequence of operations.

Another example embodiment is a computer program product comprising at least one non-transitory computer readable medium having computer program code stored thereon, wherein the computer program code, when executed by an apparatus (e.g., one or more processors), causes an apparatus to perform various functionalities. In this regard, the program code may cause the apparatus to determine that a priority of operations being implemented by the processor at a particular time during the boot process is less than a threshold priority, and in response to determining that the priority of operations being implemented by the processor is less than the threshold priority, performing at least one operation during the boot process, in advance of a scheduled position within a sequence of operations.

Another example apparatus comprises means for determining, via the thread, that a priority of operations being implemented by the processor at a particular time during the boot process is less than a threshold priority, and means for performing at least one operation during the boot process, in advance of a scheduled position within a sequence of operations, in response to determining that the priority of operations being implemented by the processor is less than the threshold priority.

### BRIEF DESCRIPTION OF THE DRAWINGS

Having thus described some example embodiments in general terms, reference will now be made to the accompanying drawings, which are not necessarily drawn to scale, and wherein:

FIG. 1 illustrates an example actions and operations to be implemented by a processor during a boot process according to some example embodiments;

FIG. 2 illustrates an example flowchart for an example operation flow for preprocessing operations during a boot process according to an example embodiment;

FIG. 3 illustrates a block diagram of an apparatus and associated system that is configured to implement preprocessing operations during a boot process according to an example embodiment;

FIG. 4 illustrates a block diagram of a mobile device configured to implement preprocessing operations during a boot process according to an example embodiment; and

FIG. 5 illustrates a flow chart of an example method for preprocessing operations during a boot process according to some example embodiments.

### DETAILED DESCRIPTION

Example embodiments will now be described more fully hereinafter with reference to the accompanying drawings, in which some, but not all embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

According to various example embodiments, during a boot process of an electronic device, if times arise where the processor is performing only low priority operations (e.g., the processor is idle), the processor may be re-purposed and utilized to perform the advance execution of operations out of their originally scheduled sequence. These operations may, for example, implemented independent of the state of the boot process. Further, operations that are part of the boot process may also be preprocessed, if it is determined that the operations are not boot state dependent or that the boot state is sufficient to support the execution of the operation in advance of its originally scheduled position within the sequence of operations to be performed. By advancing the execution of operations as described herein, the start up time of an electronic device, as perceived by a user, can be reduced, thereby improving the user experience.

Many electronic devices implement an operating system boot process to configure the operating system environment when the device is turned on or reset. During the boot process, various hardware components and memory locations may be initialized to support post-boot operation of the device. The boot process may be comprised of a number of actions. Each action may be comprised of a number of operations. The operations may be executed to configure various aspects of the operating system environment. Many conventional boot processes may be linear and/or may have synchronization points at various stages or states where one or more processes are waiting for an event to occur (e.g., an event external to the processor or complete of an operation). For example, the boot process may be waiting for activation of a hardware device (e.g., activation of communications interface hardware), establishment of a remote connection, receipt of some user input, or the like. During these example times where the processor is not being optimally utilized during the boot process, non-boot state dependent operations may be executed with little or no impact on the boot process. Further, because many electronic device operating systems implement boot processes where low priority operations are being implemented, example embodiments may be applied within the context of a variety of operating system architectures.

According to various example embodiments, determining when to preprocess operations may be implemented in a number of ways. According to some example embodiments, a decision engine may be used to determine when to perform preprocessing as described herein. For example, in some embodiments, the decision engine may be implemented by a thread or the kernel of the operating system, although in other example embodiments the decision engine may be implemented within another context, such as via a boot process application.

In some example embodiments where determination of when to preprocess is performed using a specifically configured thread, the thread may be implemented that is assigned a relatively low priority. When the processor attempts to schedule an operation having a lower priority, such as an idle operation, a decision may be made that causes the thread to be alternatively implemented, thereby triggering the preprocessing of operations in advance of the originally scheduled position within the startup sequence.

Additionally, or alternatively, in some example embodiments, the kernel of the operating system may be specifically configured to monitor the priority of the operations being executed and make decisions indicating when preprocessing should be performed. If the priority of a scheduled operation falls below a priority threshold, the kernel may generate a notification indicating that a low priority operation (e.g., an idle operation) is going to be performed and this operation may be preempted in response to the notification to trigger the preprocessing of operations.

Upon determining that a scheduled operation will have a priority that is less than a priority threshold, a thread or process may preprocess an operation that is able to advanced in the implementation sequence (e.g., is not boot state dependent). When the boot process has completed the low priority operation (e.g., when the idle time is complete), the boot process may continue to perform the remaining actions and operations in the boot process. Upon completion of preprocessing an operation, a decision engine may check the processing load and factor the processing load into a determination as whether further preprocessing of operations should be considered. A change in the state of the boot process may additionally or alternatively trigger a check of a previously missed operation and re-evaluate the operations to determine whether the missed operations can also be executed.

According to some example embodiments, as described briefly above, to preprocess operations during the boot state, a new thread may be implemented by a starter manager process of the boot process, where the new thread may have a given priority that is below a threshold priority. For example, the new thread may have a low priority, such as a priority that is one level above the priority allocated to an idle operation. In some example embodiments, a system state manager (SSM) may create the new thread with an EPriorityAbsoluteVeryLow priority. The threshold priority may be the priority allocated to an idle operation. Due to the low priority level that has been assigned to the new thread, the processor may alternatively execute the thread only when the processor is about to schedule an operation that has a priority that is lower than the thread's (e.g., when the processor is going into an idle state). As such, the processor time may be used to preprocess operations during the boot process. In this manner, the preprocessing of operations during the boot state may result, according to some example embodiments, in an increased speed of completion of post-boot state operations, since some of the operations have already been completed during the boot process. Additionally, in some example embodiments, an action list indicating the actions to be performed may be shared between a main thread and the new thread so that both threads are aware of the state of each action in the list. Further, to create the thread, according to some example embodiments, an RThread::Create command may be implemented and the priority may be set using an RThread::SetPriority command.

According to some example embodiments, a boot process may be implemented within a state management architecture, such as a System State Management Architecture (SSMA). The architecture may provide a generic, easily customizable mechanism for controlling the startup of a system. In this regard, the architecture may have control over actions and operations performed during the boot process, and the order in which actions and operations are started. The architecture may use command lists to manage the system state during the boot process. A action or command list may include a series or sequence of actions to be performed. In this regard, according to some example embodiments, an action may be starting an executable program, setting a key, or the like. According to some example embodiments, setting a key may include setting a PS (Publish and Subscribe) key as part of an inter-process communication (IPC) for peer-to-peer communications. Accordingly, setting the PS key may also involve sending an IPC and/or notifying the thread using an IPC of a state/property change. According to some example embodiments, setting a key may involve setting a central repository (CR) key, which may be used to maintain a state of a property. In some embodiments, setting the CR key may involve changing a value in a central repository. Actions may be started in linear fashion or with synchronization points after each or a group of actions.

A variety of operations that are not boot state dependent or may otherwise advanced in their processing relative to their originally schedule sequential position may be preprocessed during the boot state using the example techniques described herein. To determine which operations to preprocess, according to some example embodiments, a thread may be implemented that is provided a configuration for running required actions to be performed during the boot process. The actions may be analyzed to determine if the actions are part of the initialization of the file system, initialization of the kernel, or relating to any other system critical or resource intensive operation. With these actions being considered, the thread may also determine which actions during the boot process are conditional and determine if the condition may be preprocessed to accelerate the boot process. These conditional actions may be targeted for preprocessing. In some example embodiments, the condition may alternatively or additionally be evaluated prior to an execution of the operation to ensure that the condition has been met. According to some example embodiments, the thread that is configured with information about actions and operations that may be preprocessed may also be configured to track the state of the boot process to determine which actions or operations may be completed.

Other actions and operations may alternatively or additionally be considered for preprocessing during the boot process. For example, actions and operations that may be performed because the actions or operations are not boot state dependent and/or do not interrupt the boot process synchronization may include preparing or parsing lists or collections of the remaining actions or operations to execute in the boot process, keeping the boot process and other processes ready to execute, loading a library such as a dynamic link library, creating server session connections and preparing to pass related commands, keeping executable programs and plugins prepared for initialization and ready for execution, initializing custom actions or commands, and the like.

With respect to preparing or parsing of lists or collections of actions to be executed, according to some example embodiments, a system state manager (SSM) may be used to perform the boot process based on the prepared or parsed lists. Actions for implementation by the SSM may include starting an executable program or application, setting a PS key, running a custom command, or the like. With respect to initializing custom actions or commands, the actions may be pre-performed by loading the action and keeping the actions ready for execution. Custom actions may be loaded from a dynamic link library. In this regard, the custom actions may include, for example, setting a PS key, setting a CR key, or other custom actions that may be required.

With respect to creating processes for executable programs and keeping them ready for execution, a process for the executable program may need to be created and then later resumed when implementing an executable program. A CREATE action or command may be used which causes the executable file to be read and creates the process which is ready for execution. According to some example embodiments, prior to running an executable program, an operation may need to implemented that creates a process by reading a file (e.g., a binary file) from a file system. The file may be read from a particular path and drive. In some instances this file may be overridden by placing the filing at different paths or on a different drive. As such, security checks of the file may need to be performed, process identifiers may need to be assigned, memory may need to be allocated, a kernel side object may need to be created, and dynamic link libraries may need to be loaded. Each of these operations may be a candidates for preprocessing during the boot process, since, for example, the operations may not be dependent on the state of the boot process. Subsequent to creating the process, a RESUME action or command may be implemented that may execute the created process. As a result of the process already being created, the time to execution of the process is reduced when the execution is later performed.

These are merely a few of the many actions and operations that may be preprocessed during the boot process. It is contemplated that other types of operations may also be preprocessed in accordance with example embodiments. Additionally, different operating system architectures may lend themselves to the implementation of different actions and operations, and therefore, in some example embodiments, the actions or operations to be preprocessed may be dependent upon the operating system architecture that is being implemented.

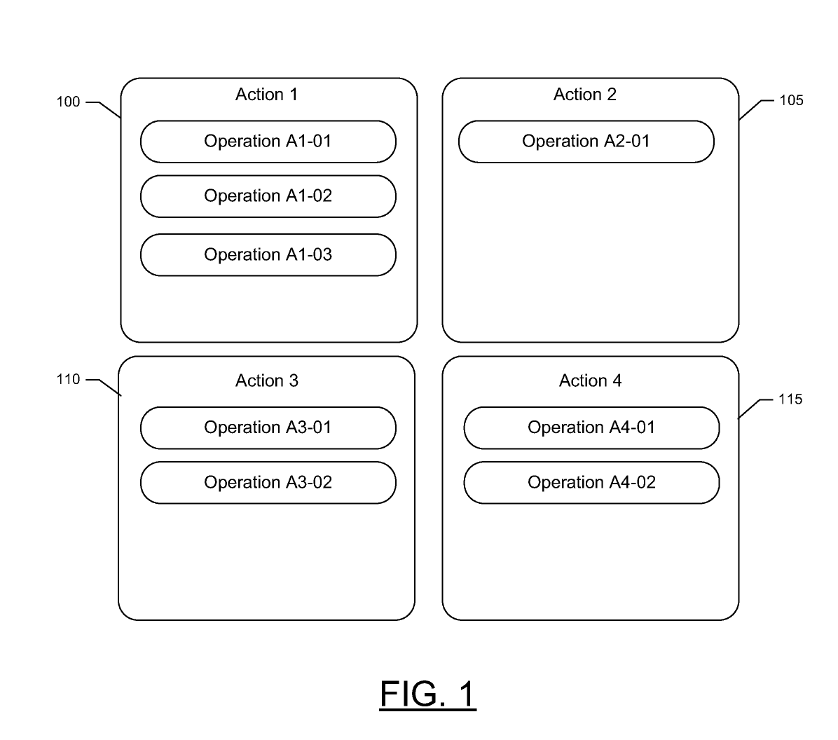

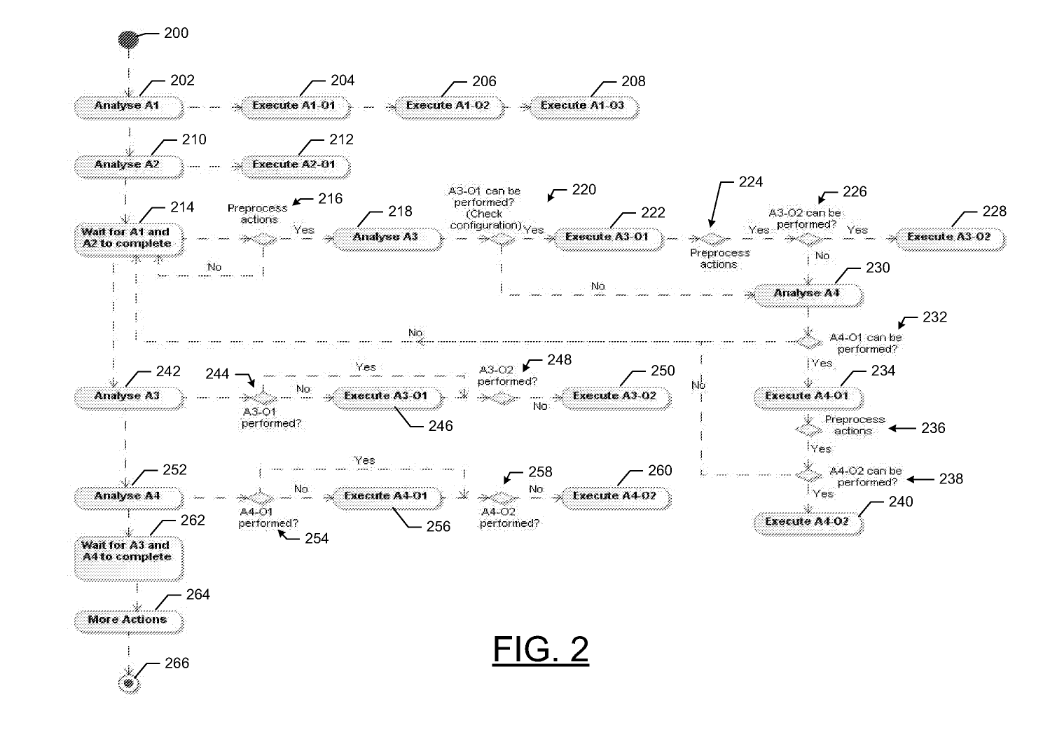

FIGS. 1 and 2 illustrate one example implementation of a boot process that involves the preprocessing of operations as described herein. FIG. 1 illustrates a collection of actions that may be scheduled for performance during or after the boot process. In this regard, the collection of actions includes Action 1 in box 100. Action 1 is comprised of three operations A1-01, A1-02, and A1-03. Action 2 in box 105 comprises operation A2-01. Action 3 in box 110 comprises operation A3-01 and A3-02. Finally, Action 4 in box 115 comprises operations A4-01 and A4-02. These actions, and there subordinate operations may be performed during a boot process, and if the boot process should implement a low priority operation (e.g., enter an idle time), then operations that are scheduled for implementation later in the sequence may be advanced to be preprocessed in accordance with various example embodiments.

FIG. 2 illustrates a flow chart of various sequences of operations that may be processed or preprocessed in accordance with example embodiments. The sequences illustrated differ from conventional boot processes, which would simply implement the operations of Action 1, followed by the operations of Action 2, followed by the operations of Action 3, followed by the operations of Action 4, in a linear fashion. Further, within the context of FIG. 2, it is contemplated that some of the decision blocks that may answered in the negative (e.g., “no”), although not depicted, return to an earlier analysis or the like. These options have, in some instances, been removed to simplify the explanation of FIG. 2.

The flowchart of FIG. 2 begins at 200 and at 202, the operations of Action 1 may be analyzed to determine if a low priority operation is included in Action 1. In this example, the operations of Action 1 have a relatively high priority and as such, the operation A1-01 is implemented at 204, operation A1-02 is implemented at 206, and operation A1-03 is implemented at 208. Similarly, the operations of Action 2 are analyzed at 210. Since the operation of Action 2 is also of a relatively high priority, operation A2-01 is implemented at 212. After implementing the operations of Actions 1 and 2, the processor is scheduled to enter a wait or idle period at 214, to wait for completion of the operations of Actions 1 and 2.

However, in accordance with various example embodiments, rather than enter the wait or idle state, the processor may consider advancing the implementation of operations or preprocessing the operations associated with Actions 3 and 4. In this regard, at 216 a determination is made as to whether preprocessing of operations may be performed. If preprocessing cannot be performed (e.g., because the execution of Actions 1 and 2 are complete and the wait period has ended), then the flow returns to 214. If preprocessing can be implemented at 216, then Action 3 is analyzed at 218. If it is determined at 220 that operation A3-01 may be preprocessed, then operation A3-01 may be implemented at 222. If it is determined at 220 that operation A3-01 may not be preprocessed, then Action 4 may be analyzed at 230. Upon preprocessing operation A3-01 at 222, a determination may be made as to whether additional preprocessing of actions may be implemented at 224. If preprocessing of actions may be implemented at 224, then a determination at 226 may be made as to whether operation A3-02 may be preprocessed. If operation A3-02 may be preprocessed, the operation A3-02 may be implemented at 228. If operation A3-02 may not be preprocessed, then Action 4 may be analyzed at 230.

Upon analyzing Action 4 at 230, a determination at 232 may be made as to whether operation A4-01 may be preprocessed. If operation A4-01 may be preprocessed, then operation A4-01 may be executed at 234. If operation A4-01 may not be preprocessed, then the flow may return to 214. After executing the operation A4-01 at 234, a determination may be made as to whether additional preprocessing of actions may be implemented at 236. If preprocessing of actions may be implemented at 236, then a determination at 238 may be made as to whether operation A4-02 may be preprocessed. If operation A4-02 may be preprocessed, then operation A4-02 may be implemented at 240. If operation A4-02 may not be preprocessed, then the flow may return to 214.

After completion of the wait or idle period at 214, the boot process may continue. At 242, Action 3 may be analyzed, and at 244 a determination may be made as to whether operation A3-01 had already been performed. If operation A3-01 has not been performed, then operation A3-01 may be performed at 246. If operation A3-01 has been performed or after having executed A3-01 at 246, a determination at 248 may be made as to whether operation A3-02 has been performed. If operation A3-02 has not been performed, then operation A3-02 may be executed at 250.

Additionally, after completion of the wait or idle period at 214 and the analysis of Action 3 at 242, the boot process may continue. At 252, Action 4 may be analyzed, and at 254 a determination may be made as to whether operation A4-01 had already been performed. If operation A4-01 has not been performed, then operation A4-01 may be performed at 256. If operation A4-01 has been performed or after having executed A4-01 at 256, a determination at 258 may be made as to whether operation A4-02 has been performed. If operation A4-02 has not been performed, then operation A4-02 may be executed at 260.

At 262, another wait or idle period in the boot process may occur while the operations of Actions 3 and 4 are being executed. During this time, more actions may possibly be preprocessed at 264. Finally, the boot process may end at 266.

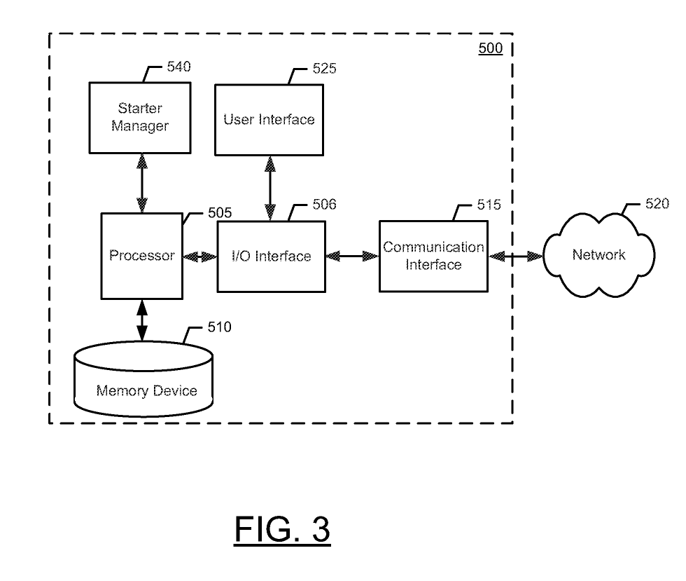

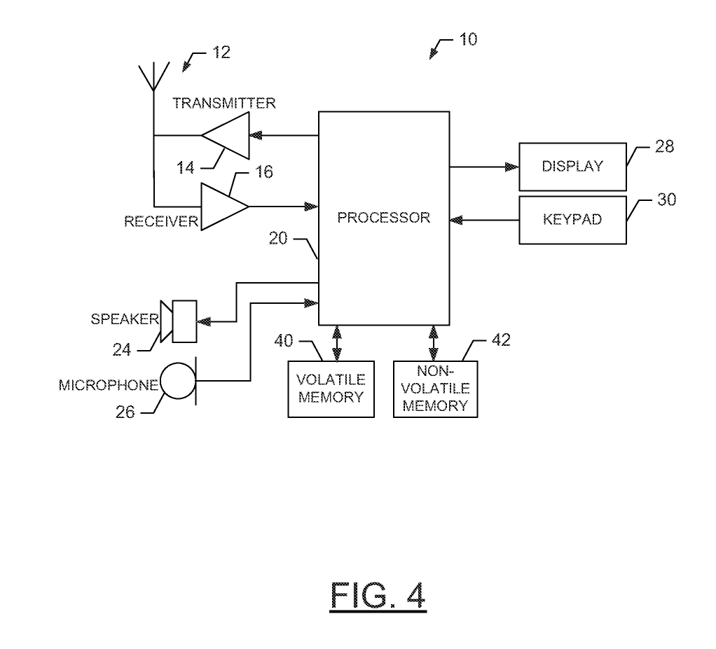

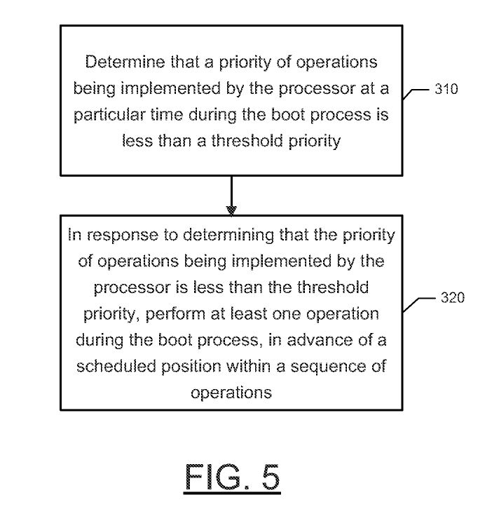

Having described some example embodiments above, FIGS. 3 and 4 depict example apparatuses that may be configured to perform various functionalities as described herein, including those described with respect to operations described above and with respect to FIGS. 1 and 2. Additionally, FIG. 5 illustrates an example method embodiment.

Referring now to FIG. 3, an example embodiment is depicted as apparatus 500, which may be embodied as an electronic device, such as a wireless communications device. In some example embodiments, the apparatus 500 may be part of a stationary or a mobile electronic device. As a mobile device, the apparatus 500 may be a mobile and/or wireless communications node such as, for example, a mobile and/or wireless server, computer, access point, handheld wireless device (e.g., telephone, tablet device, portable digital assistant (PDA), mobile television, gaming device, camera, video recorder, audio/video player, radio, digital book reader, and/or a global positioning system (GPS) device), any combination of the aforementioned, or the like. Regardless of the type of electronic device, apparatus 500 may also include computing capabilities.

FIG. 3 illustrates a block diagram of example components of the apparatus 500. The example apparatus 500 may comprise or be otherwise in communication with a processor 505, a memory device 510, an Input/Output (I/O) interface 506, a communications interface 515, a user interface 525, and a starter manager 540. The processor 505 may, according to some example embodiments, be embodied as various means for implementing the various functionalities of example embodiments including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 505 may be representative of a plurality of processors, or one or more multiple core processors, operating in concert. Further, the processor 505 may be comprised of a plurality of transistors, logic gates, a clock (e.g., oscillator), other circuitry, and the like to facilitate performance of the functionality described herein. The processor 505 may, but need not, include one or more accompanying digital signal processors. In some example embodiments, the processor 505 may be configured to execute instructions stored in the memory device 510 or instructions otherwise accessible to the processor 505. The processor 505 may be configured to operate such that the processor causes or directs the apparatus 500 to perform various functionalities described herein.

Whether configured as hardware or via instructions stored on a computer-readable storage medium, or by a combination thereof, the processor 505 may be an entity and means capable of performing operations according to example embodiments while configured accordingly. Thus, in example embodiments where the processor 505 is embodied as, or is part of, an ASIC, FPGA, or the like, the processor 505 may be specifically configured hardware for conducting the operations described herein. Alternatively, in example embodiments where the processor 505 is embodied as an executor of instructions stored on a computer-readable storage medium, the instructions may specifically configure the processor 505 to perform the algorithms and operations described herein. In some example embodiments, the processor 505 may be a processor of a specific device (e.g., mobile communications device) configured for employing example embodiments by further configuration of the processor 505 via executed instructions for performing the algorithms, methods, and operations described herein.

The memory device 510 may be one or more tangible and/or non-transitory computer-readable storage media that may include volatile and/or non-volatile memory. In some example embodiments, the memory device 510 comprises Random Access Memory (RAM) including dynamic and/or static RAM, on-chip or off-chip cache memory, and/or the like. Further, memory device 510 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), various type of solid-state storage (e.g., flash memory), and/or the like. Memory device 510 may include a cache area for temporary storage of data. In this regard, some or all of memory device 510 may be included within the processor 505. In some example embodiments, the memory device 510 may be in communication with the processor 505 and/or other components via a shared bus. In some example embodiments, the memory device 510 may be configured to provide secure storage of data, such as, for example, the characteristics of the reference marks, in trusted modules of the memory device 510.

Further, the memory device 510 may be configured to store information, data, applications, computer-readable program code instructions, and/or the like for enabling the processor 505 and the example apparatus 500 to carry out various functions in accordance with example embodiments described herein. For example, the memory device 510 may be configured to buffer input data for processing by the processor 505. Additionally, or alternatively, the memory device 510 may be configured to store instructions for execution by the processor 505.

The I/O interface 506 may be any device, circuitry, or means embodied in hardware or a combination of hardware and software that is configured to interface the processor 505 with other circuitry or devices, such as the communications interface 515. In some example embodiments, the I/O interface may embody or be in communication with a bus that is shared by multiple components. In some example embodiments, the processor 505 may interface with the memory 510 via the I/O interface 506. The I/O interface 506 may be configured to convert signals and data into a form that may be interpreted by the processor 505. The I/O interface 506 may also perform buffering of inputs and outputs to support the operation of the processor 505. According to some example embodiments, the processor 505 and the I/O interface 506 may be combined onto a single chip or integrated circuit configured to perform, or cause the apparatus 500 to perform, various functionalities.

In some embodiments, the apparatus 500 or some of the components of apparatus 500 (e.g., the processor 505 and the memory device 510) may be embodied as a chip or chip set. In other words, the apparatus 500 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 500 may therefore, in some cases, be configured to implement embodiments on a single chip or as a single “system on a chip.” As such, in some cases, a chip or chipset may constitute means for performing the functionalities described herein and with respect to the processor 505.

The communication interface 515 may be any device or means (e.g., circuitry) embodied in hardware or a combination of hardware and software that is configured to receive and/or transmit data from/to a network 520 and/or any other device or module in communication with the example apparatus 500. The communications interface may be configured to communicate information via any type of wired or wireless connection, and via any type of communications protocol, such as a communications protocol that supports cellular communications. According to various example embodiments, the communication interface 515 may be configured to support the transmission and reception of communications in a variety of networks including, but not limited to Internet Protocol-based networks (e.g., the Internet), cellular networks, or the like. Further, the communications interface 515 may be configured to support device-to-device communications, such as in a mobile ad hoc network (MANET). Processor 505 may also be configured to facilitate communications via the communications interface 515 by, for example, controlling hardware included within the communications interface 515. In this regard, the communication interface 515 may include, for example, communications driver circuitry (e.g., circuitry that supports wired communications via, for example, fiber optic connections), one or more antennas, a transmitter, a receiver, a transceiver and/or supporting hardware, including, for example, a processor for enabling communications. Via the communication interface 515, the example apparatus 500 may communicate with various other network entities in a device-to-device fashion and/or via indirect communications via a base station, access point, server, gateway, router, or the like.

The user interface 525 may be in communication with the processor 505 to receive user input via the user interface 525 and/or to present output to a user as, for example, audible, visual, mechanical, or other output indications. The user interface 525 may include, for example, a keyboard, a mouse, a joystick, a display (e.g., a touch screen display), a microphone, a speaker, camera, accelerometer, or other input/output mechanisms. Further, the processor 505 may comprise, or be in communication with, user interface circuitry configured to control at least some functions of one or more elements of the user interface. The processor 505 and/or user interface circuitry may be configured to control one or more functions of one or more elements of the user interface through computer program instructions (e.g., software and/or firmware) stored on a memory accessible to the processor 505 (e.g., volatile memory, non-volatile memory, and/or the like). The user interface 525 may also be configured to support the implementation of haptic feedback. In this regard, the user interface 525, as controlled by processor 505, may include a vibra, a piezo, and/or an audio device configured for haptic feedback as described herein. In some example embodiments, the user interface circuitry is configured to facilitate user control of at least some functions of the apparatus 500 through the use of a display and configured to respond to user inputs. The processor 505 may also comprise, or be in communication with, display circuitry configured to display at least a portion of a user interface, the display and the display circuitry configured to facilitate user control of at least some functions of the apparatus 500.

The starter manager 540 of example apparatus 500 may be any means or device embodied, partially or wholly, in hardware, a computer program product, or a combination of hardware and a computer program product, such as processor 505 implementing stored instructions to configure the example apparatus 500, memory device 510 storing executable program code instructions configured to carry out the functions described herein, or a hardware configured processor 505 that is configured to carry out the functions of the starter manager 540 as described herein. In an example embodiment, the processor 505 comprises, or controls, the starter manager 540. The starter manager 540 may be, partially or wholly, embodied as processors similar to, but separate from processor 505. In this regard, the starter manager 540 may be in communication with the processor 505. In various example embodiments, the starter manager 540 may, partially or wholly, reside on differing apparatuses such that some or all of the functionality of the starter manager 540 may be performed by a first apparatus, and the remainder of the functionality of the starter manager 540 may be performed by one or more other apparatuses.

Further, the apparatus 500 and the processor 505 may be configured to perform various functionalities via starter manager 540. In this regard, the starter manager 540 may be configured to implement the operations described herein. For example, the starter manager 540 may be configured to implement the functionality described above with respect to preprocessing of operations during a boot process. In this regard, referring to FIG. 5, the starter manager may be configured to determine that a priority of operations being implemented by the processor at a particular time during the boot process is less than a threshold priority at 310. Further, the starter manager 540 may be configured to performing at least one operation during the boot process and in advance of a scheduled position within a sequence of operations, in response to determining that the priority of operations being implemented by the processor is less than the threshold priority at 320.

Additionally, or alternatively, the starter manager 540 may be configured to determine that the priority of operations is less than a threshold priority by receiving a notification from a kernel indicating that the priority of operations to be implemented by the processor is less then the threshold priority. According to some embodiments, the starter manager 540 may be additionally or alternatively configured to implement the thread where the thread has a given priority that is less than the threshold priority, and perform the at least one operation because no higher priority threads are active. Further, according to some example embodiments, the starter manager 540 may be additionally or alternatively configured to enable customization of the given priority based on an expected processing load during the boot process. Additionally or alternatively, implementing the thread may include receiving configuration information indicating which operations may be advanced for performance during the boot process. Further, according to some example embodiments, the starter manager 540 may additionally or alternatively be configured to perform the at least one operation where the operation is one or more of generating a list of operations to be executed during the boot process, parsing operations and lists of operations to be executed, loading a library, initializing a connection session, creating processes for executable applications, or initializing plug-ins.

Referring now to FIG. 4, a more specific example apparatus in accordance with various embodiments is provided. The example apparatus of FIG. 4 is a mobile device 10 configured to communicate within a wireless network, such as a cellular communications network. The mobile device 10 may be configured to perform the functionality of the mobile device 100 or apparatus 500 as described herein. More specifically, the mobile device 10 may be caused to perform the functionality described with respect to FIGS. 1, 2, 5 and otherwise described above, via the processor 20. In this regard, according to some example embodiments, the processor 20 may be configured to perform the functionality described with respect to the starter manager 540. Processor 20 may be an integrated circuit or chip configured similar to the processor 505 together with, for example, the I/O interface 506. Further, volatile memory 40 and non-volatile memory 42 may be configured to support the operation of the processor 20 as computer readable storage media.

The mobile device 10 may also include an antenna 12, a transmitter 14, and a receiver 16, which may be included as parts of a communications interface of the mobile device 10. The speaker 24, the microphone 26, display 28 (which may be a touch screen display), and the keypad 30 may be included as parts of a user interface.

FIGS. 2 and 5 illustrate flowcharts of example systems, methods, and/or computer program products according to example embodiments. It will be understood that each operation of the flowcharts, and/or combinations of operations in the flowcharts, can be implemented by various means. Means for implementing the operations of the flowcharts, combinations of the operations in the flowchart, or other functionality of example embodiments described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions for performing the operations and functions of FIGS. 2 and 5 and otherwise described herein may be stored on a memory device, such as memory device 510, volatile memory 40, or volatile memory 42, of an example apparatus, such as example apparatus 500 or mobile device 10, and executed by a processor, such as the processor 505 or processor 20. As will be appreciated, any such program code instructions may be loaded onto a computer or other programmable apparatus (e.g., processor 505, memory device 510, or the like) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the blocks or operations of the flowcharts in a computer-readable storage medium, support combinations of operations for performing the specified functions. It will also be understood that one or more operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific ones disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

We claim:

1. A method comprising:
determining, via a processor, that a priority of operations being implemented by the processor at a particular time during the boot process is less than a threshold priority; and
in response to determining that the priority of operations being implemented by the processor is less than the threshold priority, performing at least one operation during the boot process, in advance of a scheduled position within a sequence of operations.

2. The method of claim 1, wherein determining that the priority of operations is less than a threshold priority includes receiving a notification from a kernel indicating that the priority of operations to be implemented by the processor is less then the threshold priority.

3. The method of claim 1, wherein determining that the priority of operations is less than the threshold priority includes implementing a thread having a given priority that is less than the threshold priority; and wherein performing at least one operation includes performing the at least one operation because no higher priority threads are active.

4. The method of claim 3, wherein implementing the thread with a given priority includes enabling customization of the given priority based on an expected processing load during the boot process.

5. The method of claim 1 further comprising receiving configuration information indicating which operations may be advanced for performance during the boot process.

6. The method of claim 1, wherein performing the at least one operation during the boot process in advance of the scheduled position within the sequence of operations includes performing one or more of generating a list of operations to be executed during the boot process, parsing operations and lists of operations to be executed, loading a library, initializing a connection session, creating processes for executable applications, or initializing plug-ins.

7. An apparatus comprising:
at least one processor; and
at least one memory comprising computer program code, the at least one memory and the computer program code configured to, with the at least one processor, cause the apparatus at least to:
determine that a priority of operations being implemented by the at least one processor at a particular time during the boot process is less than a threshold priority; and
in response to determining that the priority of operations being implemented by the at least one processor is less than the threshold priority, performing at least one operation during the boot process, in advance of a scheduled position within a sequence of operations.

8. The apparatus of claim 7, wherein the apparatus caused to determine that the priority of operations is less than a threshold priority includes being caused to receive a notification from a kernel indicating that the priority of operations to be implemented by the processor is less then the threshold priority.

9. The apparatus of claim 7, wherein the apparatus being caused to determine that the priority of operations is less than the threshold priority includes being caused to implement a thread having a given priority that is less than the threshold priority; and wherein being caused to perform at least one operation includes being caused to perform the at least one operation because no higher priority threads are active.

10. The apparatus of claim 9, wherein the apparatus being caused to implement the thread with a given priority includes being caused to enable customization of the given priority based on an expected processing load during the boot process.

11. The apparatus of claim 7, wherein the apparatus is further caused to receive configuration information indicating which operations may be advanced for performance during the boot process.

12. The apparatus of claim 7, wherein the apparatus being caused to perform the at least one operation during the boot process in advance of the scheduled position within the sequence of operations includes being caused to perform one or more of generating a list of operations to be executed during the boot process, parsing operations and lists of operations to be executed, loading a library, initializing a connection session, creating processes for executable applications, or initializing plug-ins.

13. The apparatus of claim 7, wherein the apparatus comprises a mobile device.

14. The apparatus of claim 13, wherein the apparatus further comprises user interface circuitry that is in communication with the at least one processor.

15. A computer program product comprising at least one computer readable medium having program code stored thereon, wherein the program code, when executed by an apparatus, causes the apparatus at least to:
determine that a priority of operations being implemented by the processor at a particular time during the boot process is less than a threshold priority; and
in response to determining that the priority of operations being implemented by the processor is less than the threshold priority, performing at least one operation during the boot process, in advance of a scheduled position within a sequence of operations.

16. The computer program product of claim 15, wherein the program code that causes the apparatus to determine that the priority of operations is less than a threshold priority also causes the apparatus to receive a notification from a kernel indicating that the priority of operations to be implemented by the processor is less than the threshold priority.

17. The computer program product of claim 15, wherein the program code that causes the apparatus to determine that the priority of operations is less than the threshold priority also causes the apparatus to implement a thread having a given priority that is less than the threshold priority; and wherein the program code that causes the apparatus to perform at least one operation also causes the apparatus to perform the at least one operation because no higher priority threads are active.

18. The computer program product of claim 17, wherein the program code that causes the apparatus to implement the thread with a given priority also causes the apparatus to enable customization of the given priority based on an expected processing load during the boot process.

19. The computer program product of claim 15, wherein the program code also causes the apparatus to receive configuration information indicating which operations may be advanced for performance during the boot process.

20. The computer program product of claim 15, wherein the program code that causes the apparatus to perform the at least one operation during the boot process in advance of the scheduled position within the sequence of operations also causes the apparatus perform one or more of generating a list of operations to be executed during the boot process, parsing operations and lists of operations to be executed, loading a library, initializing a connection session, creating processes for executable applications, or initializing plug-ins.
